(19) United States
(12) Patent Application Publication
(10) Pub. No.: US 2026/0192571 A1
(43) Pub. Date: Jul. 9, 2026

(54) METHOD FOR PREDICTING PRINT PERFORMANCE AND A RELATED PRINTER

(71) Applicant: XEROX CORPORATION, NORWALK, CT (US)

(72) Inventors: Stuart A. SCHWEID, Pittsford, NY (US); Christine A. STEURRYS, Williamson, NY (US); Shawn P. UPDEGRAFF, Fairport, NY (US)

(73) Assignee: XEROX CORPORATION, NORWALK, CT (US)

(21) Appl. No.: 19/012,632

(22) Filed: Jan. 7, 2025

(51) Int. Cl. B41J 2/21; B41J 2/165; B41J 29/00

(52) U.S. Cl. CPC B41J 2/2103; B41J 2/1652; B41J 29/00; B41J 2002/16573

(57) ABSTRACT

An ink-jet printer configured to generate a print performance prediction by producing a nozzle failure rate estimate based at least in part on a current missing nozzle list for the print head is presented. Related methods of predicting print performance of an ink-jet printer are also presented.

### TECHNICAL FIELD

The disclosure relates to printing using a liquid ink printer, and more specifically to systems and methods to predict print performance of liquid ink printers.

### BACKGROUND

Liquid ink printers, such as ink-jet printers, are used to deposit ink on a print substrate or recording media, such as paper, to create an image in the form of text and/or graphics. In ink jet printing print quality degrades over time and maintenance, such as purging, is needed to restore the jets to a given level of print performance. One commonly used method is performing maintenance on a given schedule, such as after a certain time or print count. If the interval is too long, then print quality degrades producing substandard prints; an interval that is too short results in decreased productivity and unnecessary ink usage.

Accordingly, there is a need for additional systems and methods to predict print performance of liquid ink printers, including ink-jet printers.

### BRIEF SUMMARY

This summary is intended merely to introduce a simplified summary of some aspects of one or more implementations of the present disclosure. This summary is not an extensive overview, nor is it intended to identify key or critical elements of the present teachings, nor to delineate the scope of the disclosure. Rather, its purpose is merely to present one or more concepts in simplified form as a prelude to the detailed description below.

The foregoing and/or other aspects and utilities exemplified in the present disclosure may be achieved by providing an ink-jet printer including at least one print head comprising one or more nozzles and at least one controller operatively connected to the least one print head, wherein the controller comprises at least one processor and at least one memory communicatively coupled to the processor, the memory storing non-transitory instructions which, when executed by the processor, perform operations comprising: generating a print performance prediction for the ink-jet printer by producing one or more nozzle failure rate estimates at one or more selected time points based at least in part on a current missing nozzle list for the print head.

In some implementations, generating the print performance prediction for the ink-jet printer comprises calculating a streak score using a known number, and locations, of the failed nozzles in the print head as reflected in the current missing nozzle list. In some implementations, the non-transitory instructions which, when executed by the processor, further perform operations comprising: performing one or more maintenance protocols on at least a portion of the one or more of nozzles in the print head, which maintenance protocols comprise purging at least the portion of the one or more of nozzles in the print head.

In some implementations, generating the print performance prediction for the ink-jet printer comprises producing the one or more nozzle failure rate estimates at the one or more selected time points using at least one binomial distribution of nozzle failures created using a known number, and locations, of failed nozzles in the print head. In some implementations, generating the print performance prediction for the ink-jet printer comprises using contiguous groups of selected consecutive nozzles from the at least one print head. In some implementations, generating the print performance prediction for the ink-jet printer comprises creating the binomial distribution of nozzle failures using the groups of selected consecutive nozzles from the at least one print head. In some implementations, generating the print performance prediction for the ink-jet printer comprises: producing at least one histogram that shows numbers of the groups of selected consecutive nozzles from the at least one print head that have a given number of the nozzle failures, wherein the given number of the nozzle failures is from one to a number of the selected consecutive nozzles in each group; and determining the one or more nozzle failure rate estimates at the one or more selected time points using the at least one histogram. In some implementations, generating the print performance prediction for the ink-jet printer comprises: creating at least one vector, wherein each location of a failed nozzle is assigned a value of 1 in the at least one vector and wherein all other nozzles are assigned a value of 0 in the at least one vector; and convolving the at least one vector with at least one function. In some implementations, generating the print performance prediction for the ink-jet printer comprises: weighting at least one of the one or more nozzle failure rate estimates.

In some implementations, the non-transitory instructions which, when executed by the processor, further perform operations comprising: receiving as user selected input one of at least three image quality modes prior to or when generating the print performance prediction for the ink-jet printer, wherein the image quality modes comprise a high quality mode, a medium quality mode, and a basic quality mode, wherein the high quality mode produces images having a higher image quality, and at a potentially lower productivity rate, than images produced using the medium quality mode, and wherein the medium quality mode produces images having a higher image quality, and at a potentially lower productivity rate, than images produced using the basic quality mode.

The foregoing and/or other aspects and utilities exemplified in the present disclosure may also be achieved by providing a method of predicting print performance of an ink-jet printer, the method comprising producing at least one nozzle failure rate estimate for at least one print head of the ink-jet printer at one or more selected time points based at least in part on a current missing nozzle list for the print head, thereby predicting print performance of an ink-jet printer.

In some implementations, the method comprises generating at least one print performance prediction for the ink-jet printer by calculating a streak score using a known number, and locations, of the failed nozzles in the at least one print head as reflected in the current missing nozzle list. In some implementations, the method further comprises performing one or more maintenance protocols on at least a portion of the one or more of nozzles in the at least one print head, which maintenance protocols comprise purging at least the portion of the one or more of nozzles in the at least one print head.

In some implementations, the method comprises producing the at least one nozzle failure rate estimate at the one or more selected time points using at least one binomial distribution of nozzle failures of the at least one print head of the ink-jet printer created using a known number, and locations, of failed nozzles in the at least one print head. In some implementations, the method comprises generating at least one print performance prediction for the ink-jet printer using contiguous groups of selected consecutive nozzles from the at least one print head. In some implementations, generating the print performance prediction for the ink-jet printer comprises creating the binomial distribution of nozzle failures using the groups of selected consecutive nozzles from the at least one print head. In some implementations, generating the print performance prediction for the ink-jet printer comprises: producing at least one histogram that shows numbers of the groups of selected consecutive nozzles from the at least one print head that have a given number of the nozzle failures, wherein the given number of the nozzle failures is from one to a number of the selected consecutive nozzles in each group; and determining the one or more nozzle failure rate estimates at the one or more selected time points using the at least one histogram. In some implementations, generating the print performance prediction for the ink-jet printer comprises: creating at least one vector, wherein each location of a failed nozzle is assigned a value of 1 in the at least one vector and wherein all other nozzles are assigned a value of 0 in the at least one vector; and convolving the at least one vector with at least one function. In some implementations, generating the print performance prediction for the ink-jet printer comprises: weighting at least one of the one or more nozzle failure rate estimates.

In some implementations, the method further comprises receiving as user selected input one of at least three image quality modes prior to or when generating at least one print performance prediction for the ink-jet printer, wherein the image quality modes comprise a high quality mode, a medium quality mode, and a basic quality mode, wherein the high quality mode produces images having a higher image quality, and at a potentially lower productivity rate, than images produced using the medium quality mode, and wherein the medium quality mode produces images having a higher image quality, and at a potentially lower productivity rate, than images produced using the basic quality mode.

Further areas of applicability will become apparent from the detailed description provided hereinafter. It should be understood that the detailed description and specific examples, while indicating the preferred implementation of the invention, are intended for purposes of illustration only and are not intended to limit the scope of the invention.

### BRIEF DESCRIPTION OF THE DRAWINGS

The accompanying drawings, which are incorporated in, and constitute a part of this specification, illustrate implementations of the present teachings and, together with the description, serve to explain the principles of the disclosure. In the figures:

FIG. 1 illustrates an ink-jet printer according to implementations of the present disclosure.

FIG. 2 illustrates a method of predicting print performance of an ink-jet printer according to implementations of the present disclosure.

FIG. 3 illustrates a method of performing a maintenance protocol on a print head of an ink-jet printer according to implementations of the present disclosure.

FIGS. 4A and 4B illustrate plots of a missing nozzle or jet pulse train (x-axis represents jet number, y-axis represents failed jets) and local group failures (x-axis represents jet number, y-axis represents failed jet groups), respectively, that can be used to create histograms according to implementations of the present disclosure.

FIGS. 5A and 5B are screenshots showing optional settings when selecting basic quality and high quality print quality assurance options, respectively, according to implementations of the present disclosure.

It should be noted that some details of the figures have been simplified and are drawn to facilitate understanding of the present teachings rather than to maintain strict structural accuracy, detail, and scale.

### DETAILED DESCRIPTION

Reference will now be made in detail to exemplary implementations of the present teachings, examples of which are illustrated in the accompanying drawings. Generally, the same reference numbers will be used throughout the drawings to refer to the same or like parts.

Throughout the specification and claims, the following terms take the meanings explicitly associated herein, unless the context clearly dictates otherwise. Phrases, such as, “in an implementation,” “in certain implementations,” and “in some implementations” as used herein do not necessarily refer to the same implementation(s), though they may. Furthermore, the phrases “in another implementation” and “in some other implementations” as used herein do not necessarily refer to a different implementation, although they may. As described below, various implementations can be readily combined, without departing from the scope or spirit of the present disclosure.

As used herein, the term “or” is an inclusive operator, and is equivalent to the term “and/or,” unless the context clearly dictates otherwise. The term “based on” is not exclusive and allows for being based on additional factors not described unless the context clearly dictates otherwise. In the specification, the recitation of “at least one of A, B, and C,” includes implementations containing A, B, or C, multiple examples of A, B, or C, or combinations of A/B, A/C, B/C, A/B/B/B/B/C, A/B/C, etc. In addition, throughout the specification, the meaning of “a,” “an,” and “the” include plural references. The meaning of “in” includes “in” and “on.” Similarly, implementations of the present disclosure may suitably comprise, consist of, or consist essentially of, the elements A, B, C, etc.

It will also be understood that, although the terms first, second, etc. can be used herein to describe various elements, these elements should not be limited by these terms. These terms are only used to distinguish one element from another. For example, a first object, component, or step could be termed a second object, component, or step, and, similarly, a second object, component, or step could be termed a first object, component, or step, without departing from the scope of the invention. The first object, component, or step, and the second object, component, or step, are both, objects, component, or steps, respectively, but they are not to be considered the same object, component, or step. It will be further understood that the terms “includes,” “including,” “comprises” and/or “comprising,” when used in this specification, specify the presence of stated features, steps, operations, elements, and/or components, but do not preclude the presence or addition of one or more other features, steps, operations, elements, components, and/or groups thereof. Further, as used herein, the term “if” can be construed to mean “when” or “upon” or “in response to determining” or “in response to detecting,” depending on the context.

When referring to any numerical range of values herein, such ranges are understood to include each and every number and/or fraction between the stated range minimum and maximum, as well as the endpoints. For example, a range of 0.5% to 6% would expressly include all intermediate values of, for example, 0.6%, 0.7%, and 0.9%, all the way up to and including 5.95%, 5.97%, and 5.99%, among many others. The same applies to each other numerical property and/or elemental range set forth herein, unless the context clearly dictates otherwise.

Additionally, all numerical values are “about” or “approximately” the indicated value, and take into account experimental error and variations that would be expected by a person having ordinary skill in the art. It should be appreciated that all numerical values and ranges disclosed herein are approximate values and ranges. The terms “about” or “substantial” and “substantially” or “approximately,” with reference to amounts or measurement values, are meant that the recited characteristic, parameter, or values need not be achieved exactly. Rather, deviations or variations, including, for example, tolerances, measurement error, measurement accuracy limitations, and other factors known to those skilled in the art, may occur in amounts that do not preclude the effect that the characteristic was intended to provide.

With regard to procedures, methods, techniques, and workflows that are in accordance with some implementations, some operations in the procedures, methods, techniques, and workflows disclosed herein can be combined and/or the order of some operations can be changed.

As used herein, the terms “print media,” “print substrate,” and “print sheet” generally refer to a porous paper, usually embodied as a physical print media substrate, sheet, web, etc., for images or text, whether precut or web fed.

The terms “printer,” “printing device,” or “printing system” as used herein refers to a digital copier or printer, scanner, image printing machine, xerographic device, electrostatographic device, digital production press, document processing system, image reproduction machine, bookmaking machine, facsimile machine, multi-function machine, or generally an apparatus useful in performing an ink-jet print process using liquid inks or the like and can include several marking engines, feed mechanism, scanning assembly as well as other print media processing units, such as paper feeders, finishers, and the like. A “printing system” may handle sheets, webs, substrates, and the like. A “printing system” can place marks on any surface, and the like, and is any machine that reads marks on input sheets; or any combination of such machines.

As used herein, the term “aqueous liquid ink” refers to a liquid ink wherein water is a principal component. For example, a typical composition for a water-based or aqueous liquid ink includes from about 40 weight % to about 80 weight % water. In some cases, a water-based ink may include more than 50 weight % water. An aqueous liquid ink may include other solvents and components. For example, from about 20 weight % to about 50 weight % co-solvents, such as butane diol, hexanediol, glycerol, propylene glycol, PEG ethers, etc., from about 2 weight % to about 10 weight % colorant, from about 1 weight % to about 5 weight % surfactants, and from about 1 weight % to about 4 weight % of other additives, such as a wax.

The term “colorant,” as used herein refers to any colorant, pigment, or dye suitable for use with a liquid ink, and configured to produce a print image after drying or fixing to a print substrate.

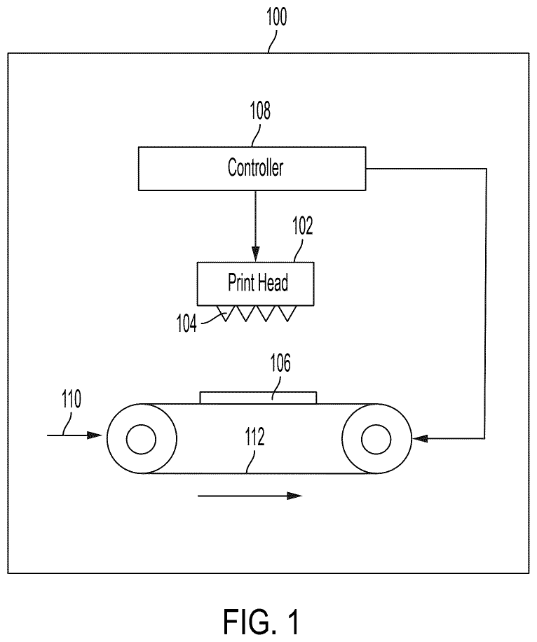

For general understanding of the environment for the printer and the printer operational method disclosed herein, FIG. 1 illustrates an ink-jet printer according to implementations of the present disclosure. As illustrated in FIG. 1, an ink-jet printer 100 comprises a print head 102 (e.g., a single color (monochrome) print head, a CMYK print head having one or more cyan printing nozzles, one or more magenta printing nozzles, one or more yellow printing nozzles, and one or more black printing nozzles, or other print head types) having jets or nozzles 104 configured to deposit a liquid ink onto a print substrate 106, wherein the liquid ink typically comprises a colorant and is configured for deposit on the print substrate 106 to form a print image As additionally illustrated in FIG. 1, the ink-jet printer 100 also includes a controller 108 operatively connected to the print head 102, wherein the controller 108 comprises at least one processor and at least one memory communicatively coupled to the processor. The memory stores non-transitory instructions which, when executed by the processor, perform operations as described in the present disclosure or otherwise known to persons having ordinary skill in the art. In the implementation shown in FIG. 1, the ink-jet printer 100 also includes a substrate transport 110 configured to move a print substrate through a print zone opposite the at least one print head 102 in a process direction (directional arrow) using a transport belt 112.

In some implementations, the controller 108 is a self-contained computer having a central processor unit (CPU) with electronic data storage, and a display or user interface (UI). The controller 108, for example, can include a sensor input and control circuit as well as a pixel placement and control circuit. In addition, the CPU typically reads, captures, prepares, and manages the image content data flow between image input sources, such as a scanning system or an online or a work station connection (not shown), and the print head 102. As such, the controller 108 is the main multi-tasking processor for operating and controlling all of the other machine subsystems and functions, including the printing process according to some implementations.

In some implementations, the controller 108 can be implemented with general or specialized programmable processors that execute programmed instructions. The instructions and data used to perform the programmed functions can be stored in memory associated with the processors or controllers. The processors, their memories, and interface circuitry configure the controllers to perform the operations described herein or otherwise known. These components can be provided on a printed circuit card or provided as a circuit in an application specific integrated circuit (ASIC). Each of the circuits can be implemented with a separate processor or multiple circuits can be implemented on the same processor. Alternatively, the circuits can be implemented with discrete components or circuits provided in very large scale integrated (VLSI) circuits. Also, the circuits can be implemented with a combination of processors, ASICs, discrete components, or VLSI circuits.

In operation, ink image content data for an ink image to be produced is typically sent to the controller 108 from either a scanning system or an online or work station connection. The ink image content data is processed to generate the ink-jet ejector firing signals delivered to the print head 102. Along with the ink image content data, the controller typically receives print job parameters that identify the media weight, media dimensions, print speed, media type, ink area coverage to be produced on each side of each sheet, location of the image to be produced on each side of each sheet, media color, media fiber orientation for fibrous media, print zone temperature and humidity, media moisture content, and media manufacturer. As used in this document, the term “print job parameters” means non-image content data for a print job and the term “ink image content data” means digital data that identifies a color and a volume of each ejected ink drop that forms pixels in an ink image to be printed on the print substrate 106.

Although not shown in FIG. 1, the ink-jet printer 100 optionally includes additional components. In some implementations, for example, the ink-jet printer 100 further includes at least one optical sensor that precedes and/or follows the print zone in the process direction. In some implementations, the ink-jet printer 100 further includes at least one dryer that follows the at least one print head 102 in the process direction, which dryer is configured to expose the print substrate 106 to heat. In some implementations, the ink-jet printer 100 further includes at least one return path that returns the print substrate 106 to the at least one substrate transport 110. In these implementations, the at least one controller 108 is typically operatively connected to an actuator that diverts the print substrate 106 onto the at least one return path.

Mindful of the foregoing context, in ink jet printing print quality tends to degrade over time and maintenance (e.g., jet or nozzle purging) is needed to restore the jets to a given level of operation. One commonly used process is performing maintenance on a given schedule, such as after a certain time or print count. If the interval between scheduled maintenance is too long, then print quality degrades producing substandard prints. In contrast; an interval between scheduled maintenance that is too short, generally results in decreased productivity and unnecessary ink usage. Accordingly, in some implementations, the present disclosure provides an ink-jet printer and a method that uses a current missing (e.g., non-firing) jet or nozzle list to predict the print performance. The missing jet list is typically a list of non-firing jets that is created in real-time after measuring a calibration print that fires all jets and analysis is used to determine which of the heads' jets have not fired.

One metric used for determining print head health or operational status is the failure rate of the jets or nozzles. In the simplest estimate, the expected failure rate is the number of jets that are not firing divided by the total number of jets. The problem with this simple estimate is that it weights jets that are failing in proximity equal to jets that are firing in isolation, the resultant image quality, however, is much more sensitive to jet cluster failures than isolated jet failures. This is true for two main reasons: first, the jets failing in isolation are much less noticeable than groups of jets failing near each other. Additionally, missing jet correction can effectively compensate for isolated or pairs of missing jets failing but it cannot do so for large continuous blocks of missing jets or large numbers of failing jets in one area (e.g., 3 of 5 continuous jets failing, 5 of 10 continuous jets failing, or the like).

Jets with large Xdp (off-axis) errors both reduce image quality and are often indicative of poor performance (e.g., dual drop). It is therefore useful to append the missing jet list with those jets that have large Xdp errors and use the expanded list in any analysis. Future references to missing jet lists will therefore refer to either a true list of missing jets or an expanded list that includes jet with large Xdp errors.

The list of missing jets or nozzles can be converted to a set of Bernoulli trials by breaking the jets into groups of N consecutive jets. For example, if N is 10 and there are 10000 jets (J), then 1000 groups (G), of 10 jets each can be formed. The first group of jets would be jets comprised of jets 1-10, the next group would contain jets 11-20, etcetera, with the last group being jets 9991-10000. For the complete set of groupings, a histogram, H, can be calculated where each entry corresponded to the number of occurrences of missing jets: for example H (2) would be the number of groups with 2 missing jets (of the 10 jets of the group). If the histogram is divided by the number of groups that gives a relative occurrence or probability estimate, \hat{P}(k), of having k missing jets in a group.

From an implementation viewpoint, the histogram and probability estimate can be found by creating a vector where each missing jet location are assigned a value of 1 and all functioning jets are assigned a value of 0, i.e.,

$$MJV ( i ) = \{ 0 if {jet}_{i} is good , 1 if if {jet}_{i} is bad \}$$

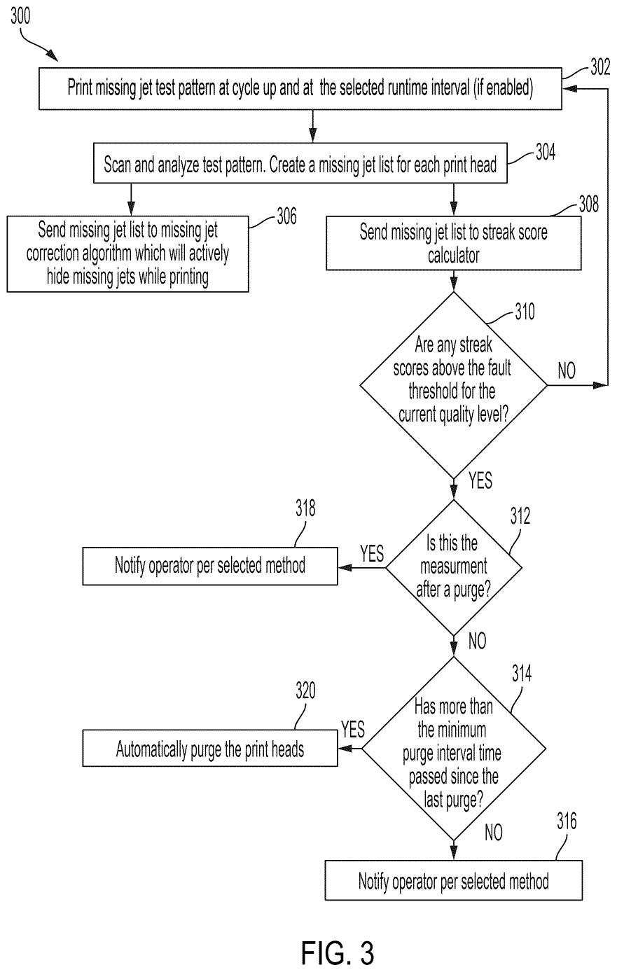

This vector is then convolved with a rectangular or rect function with a length of N. The resultant output is subsampled every N locations to create the number of jets that are missing in each subgroup of N pixels. For the example above, the convolution would occur with a vector of 10 ones (N==10) and then subsampled by keeping every N pixels. This makes the implementation efficient. Moreover, the output convolution does not need to be subsampled, but a direct histogram can be taken. The values of that histogram can be divided by N, and this is equivalent to averaging all possible combinations of groupings of N jets at a time so that a shift in the missing jet pattern will produce an identical output. An example pulse train and filtered output that can be used for the histogram creation are shown in FIGS. 3A and 3B.

From the binomial distribution it is known that probably of getting k events, \hat{P}(k), in N opportunities is:

$$P ( k ) = ( \begin{matrix}N \\ k\end{matrix} ) {{λ}^{k} ( 1 - λ )}^{N - k} \qquad ( 1 )$$

where λ is the probability of a jet failure. Given that we have the probability estimate, \hat{P}(k), the above equation (1) can be solved for the maximum likelihood value of λₖ, the failure rate for each entry of the probability estimate, \hat{P}(k). It is shown as a minimization:

$${λ}_{k} = arg min ( {\{ \hat{P} ( k ) - ( \begin{matrix}N \\ k\end{matrix} ) {{λ}_{k}^{k} ( 1 - {λ}_{k} )}^{N - k} \}}^{2} ) \qquad ( 2 )$$

Note that there may not be a solution to (2), as λₖ is limited between 0 and 1. Furthermore, the inverse function may not be unique—there may be more than on value of Ak which results in the same probability. To eliminate this concern, we rewrite (2) as:

$${λ}_{k} = arg min ( 2 {\{ \hat{P} ( k ) - ( \begin{matrix}N \\ k\end{matrix} ) {{λ}_{k}^{k} ( 1 - {λ}_{k} )}^{N - k} \}}^{2} ) , 0 < = {λ}_{k} < = k / N \qquad ( 2 a )$$

This will have a unique solution for all possible \hat{P}(k), even if solution does not give an exact estimate of \hat{P}(k). Equation (2a) provides N failure rate estimates (i.e., k=1 to N) and they need to be combined into a single missing jet rate metric.

Using an average is one possibility but it tends to not weight large failure rates strongly enough. For example, if 50 jets in a row are missing then λ_{N} would be large but all the other failure rate estimates would be small. If they were all averaged the strong failure rate estimate would be significantly attenuated and the resultant average would not capture a true significant effect. Additionally, all bins where \hat{P}(k)=0 will greatly reduce the average.

In order to eliminate the problem of small failure rate estimates masking large failure rate errors, the failure rate vector is reduced to a single estimate by weighting the large estimates more heavily. One way to do this is to use:

$${λ}_{e} = \frac{{λ}_{k}^{′} * {λ}_{k}}{sum ( {λ}_{k} )} = \frac{{\vert {λ}_{k} \vert}_{2}^{2}}{{\vert {λ}_{k} \vert}_{1}} \qquad ( 3 )$$

This will give a weight to each failure rate equal to its value—higher failure rates have higher weights and lower failure rates have lower ones—this will also ensure that when \hat{P}(k)=0 there is no effect on the final failure rate.

The above analysis is valid when the failure rate of jets seems to be uniform globally and not vary locally. Typically, however, the jets often fail at a higher rate in a specific area. This would give a higher value failure rate if the analysis were only done over the known specific area. Once the probabilities are averaged over the whole jet space the failure rate estimates are decreased; this can hide commonly seen areas with many missing jets.

To minimize this problem, it is necessary to determine if the failures can be attributed to a localized area. One way to do this is to look at the failure rate corresponding to 1 and 2 failures per group only. From the histogram the following equation (4) can be obtained:

$$\begin{matrix}\frac{H ( 2 )}{H ( 1 )} = \frac{N ( N - 1 ) / 2 {{λ}^{2} ( 1 - λ )}^{N - 2}}{N * {λ ( 1 - λ )}^{N - 1}} \\ = \frac{( N - 1 ) λ}{2 * ( 1 - λ )} \to \frac{λ}{( 1 - λ )} \\ = \frac{2 H ( 2 )}{( N - 1 ) H ( 1 )}\end{matrix} \qquad ( 4 )$$

In equation (4) the number of pairs of missing jets, J(2) will relatively grow much quicker in the areas of high missing jet rates compared to the rate of growth of isolated jets, H(1), increasing the ratio. This will increase the value of λ.

Equation (4) can be solved for λ, which is the estimate just using the isolated (1 per group) and near pairs (2 per group) of missing jets. Once the failure rate has been found, the number of estimated groups would be:

$${G}_{loc} = H ( 1 ) / ( N * {λ ( 1 - λ )}^{N - 1} ) = H ( 2 ) / ( N ( N - 1 ) / 2 {{λ}^{2} ( 1 - λ )}^{N - 2} ) \qquad ( 5 )$$

$${J}_{loc} = N * {G}_{loc}$$

Here G_{loc} is the estimated number of groups needed for the calculation of occurrence probability, \hat{P}_{loc}(k), from the measured histogram H and J_{loc} is the number of localized bad jets. G_{loc} should be smaller than or equal to the complete number of groups G: it is used to focus in on areas where missing jets is locally represented. In instances where the calculation gives a larger than G_{loc} than G, G_{loc} is set equal to G. \hat{P}_{loc}(k), is calculated by dividing the histogram by the localized number of groups, G_{loc}, instead of the full number, G.

The calculation of the missing jet failure rate given \hat{P}_{loc}(k), proceeds identically as before, with the only difference is that \hat{P}_{loc}(k) replaces \hat{P}(k) in equations (2) and (2a). Once the failure rate is determined, the system can decide, based on desired image quality (IQ), if current performance is acceptable or if maintenance (e.g., purging) should occur.

Accordingly, in some implementations, the non-transitory instructions of the at least one controller 108 which, when executed by the processor, perform operations comprising: generating a print performance prediction for the ink-jet printer 100 by producing one or more nozzle failure rate estimates at one or more selected time points using at least one binomial distribution of nozzle failures created using a known number, and locations, of failed nozzles in the print head 102. In some implementations, generating the print performance prediction for the ink-jet printer 100 is performed based at least in part on a current missing nozzle list for the print head. In some implementations, the known number, and the locations, of the failed nozzles in the print head 102 are current.

In some implementations, a list or table comprises the known number, and the locations, of the failed nozzles in the print head 102. In some implementations, the non-transitory instructions which, when executed by the processor, further perform operations comprising: appending additional nozzles to the list or table when the additional nozzles exhibit off-axis errors that exceed a predetermined error threshold to produce an expanded set of failed nozzles in the print head 102; and repeating generating the print performance prediction for the ink-jet printer 100 using the expanded set of failed nozzles in the print head 102. In some implementations, the non-transitory instructions which, when executed by the processor, further perform operations comprising: performing one or more maintenance protocols on at least a portion of the one or more of nozzles 104 in the print head 102 when the at least one nozzle failure rate estimate exceeds a predetermined failure rate value.

In some implementations, generating the print performance prediction for the ink-jet printer 100 comprises using contiguous groups of selected consecutive nozzles from the at least one print head 102. In some implementations, generating the print performance prediction for the ink-jet printer 100 comprises creating the binomial distribution of nozzle failures using the groups of selected consecutive nozzles from the at least one print head 102. In some implementations, generating the print performance prediction for the ink-jet printer 100 comprises: producing at least one histogram that shows numbers of the groups of selected consecutive nozzles from the at least one print head 102 that have a given number of the nozzle failures, wherein the given number of the nozzle failures is from one to a number of the selected consecutive nozzles in each group; and determining the one or more nozzle failure rate estimates at the one or more selected time points using the at least one histogram. In some implementations, generating the print performance prediction for the ink-jet printer 100 comprises: creating at least one vector, wherein each location of a failed nozzle is assigned a value of 1 in the at least one vector and wherein all other nozzles are assigned a value of 0 in the at least one vector; and convolving the at least one vector with at least one function. In some implementations, generating the print performance prediction for the ink-jet printer 100 comprises: weighting at least one of the one or more nozzle failure rate estimates. In some implementations, generating the print performance prediction for the ink-jet printer 100 comprises: estimating at least one selected subgroup size to produce at least one selected subgroup size estimate; and using the at least one selected subgroup size estimate to produce the one or more nozzle failure rate estimates at the one or more selected time points.

In some implementations, generating the print performance prediction for the ink-jet printer 100 comprises calculating a streak score using the known number, and the locations, of the failed nozzles in the print head 102 as reflected in the current missing nozzle list. In some implementations, the non-transitory instructions which, when executed by the processor, further perform operations comprising: performing one or more maintenance protocols on at least a portion of the one or more of nozzles 104 in the print head 102, which maintenance protocols comprise purging at least the portion of the one or more of nozzles 104 in the print head 102. In some implementations, the purging step comprises purging all nozzles 104 of an identical ink color when a predetermined threshold streak score is exceeded. In some implementations, the purging step comprises purging all nozzles 104 having streak scores that exceed a lower limit of the predetermined threshold streak score. In some implementations, a given purging step is automatically performed when a predetermined threshold time interval since a performing previous purging step is exceeded. In some implementations, the predetermined time interval is independently set for each image quality mode and different ink color. In some implementations, the controller outputs a fault notice to a user when the streak score exceeds the predetermined threshold streak score and a predetermined time interval since performing a previous purging step is not exceeded. In some implementations, a timing for performing a given purging step is determined at least in part based on a quality mode selected and/or a streak score determined for print substrates using the ink-jet printer. In some implementations, the non-transitory instructions which, when executed by the processor, further perform operations comprising: outputting a notice to a user when the streak score determined for the print substrate 106 exceeds a predetermined threshold streak score and/or another problem associated with the print head 102 is indicated. In some implementations, the predetermined threshold streak score is independently set for each image quality mode and different ink color.

In order to maintain high levels of image quality, ink-jet printers generally need process controls such as missing jet detection, print head alignment adjustments and density optimization (e.g., cross process density smoothing). These adjustments take time, reducing productivity. Many users purchase the same production printers expecting high productivity. They may have print jobs with less challenging image content or may have less stringent image quality (IQ) requirements. These users will often reduce or disable process controls. There is also a large group of users that are tolerant of a low level of IQ artifacts in exchange for a small amount of lost productivity due to IQ adjustments. Due to these varying needs, users are provided with many options to tailor the ink-jet printer to work best for them. They can enable/disable some of the control algorithms, change missing jet fault thresholds, change the intervals between purges, etc. This works for well-educated ink-jet printer operators, however many users may be low-skill operators who may not understand how to tailor the printer. More importantly, they may not understand the implications of the various control changes.

To address these problems, in some implementations, ink-jet printer 100 includes a print quality assurance (PQA) feature. In some implementations, a user can select an image quality mode (e.g., a high quality mode, which has the highest image quality/a potentially lower productivity level, a medium quality mode, which has a moderate image quality/a good productivity level, and a basic quality mode, which has the lowest image quality/the highest productivity level). In some implementations, runtime adjustment controls will change based on selected quality levels. In high quality mode, for example, missing jet updates are automatically enabled, and print head registration and density optimization can be enabled or disabled according to some implementations. In medium quality mode, missing jet updates, print head registration and density optimization can be enabled or disabled according to some implementations. In basic quality mode, users may enable missing jet updates, while print head registration and density optimization are not available according to some implementations.

In some implementations, print head purges are performed periodically to clear missing jets, as described herein. Purge timing varies based on the quality mode and the streakiness of the prints according to some implementations. When a printer is operating properly, all purges will typically be automatic. If there is a problem clearing jets or if the missing jets return too quickly, the operator is notified of the problem for awareness that the machine may need to be serviced according to some implementations.

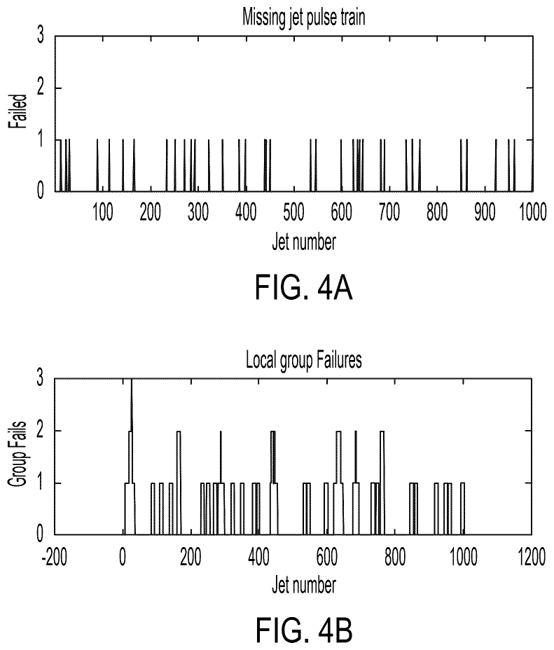

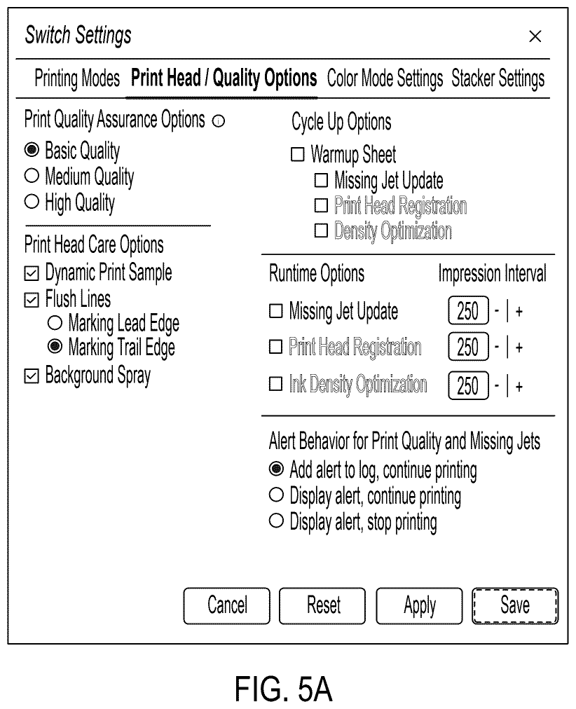

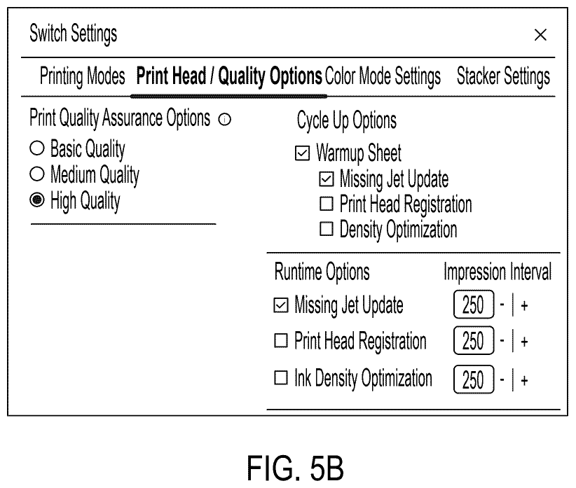

In some implementations, as referenced herein, a streak score is calculated using a missing jet list. It generally uses the number of missing jets and the locations of those jets or nozzles with respect to each other to quantify the streakiness of a print in some implementations. In some implementations, a streak score fault limit is set independently for each quality mode and ink color to meet the IQ/productivity targets for that mode. In some implementations, if the streak score fault threshold is exceeded on the first missing jet measurement following a purge, a “streak condition not resolving” fault is raised. In some implementations, if more than “min_miniPurgeInterval” time has passed since the last purge, a mini-purge will automatically be performed. This interval is also typically set independently for each quality mode and ink color. If “min_miniPurgeInterval” time has not passed, a “streak condition sooner than allowable” fault will be raised in some implementations. In some implementations, any time a mini-purge is scheduled for an elevated streak score, all print heads in that color will purge along with any having a streak score above a lower limit called the ‘PurgeLevel.” In some implementations, if users disable all process controls, a “mini-purge threshold” is used. Mini-purges are automatically performed at the interval defined for each quality mode and ink color in some implementations. To illustrate, FIGS. 4A and 4B are screenshots showing optional settings when selecting basic quality and high quality print quality assurance options, respectively, according to implementations of the present disclosure. To further illustrate, Table 1 provides an exemplary set of parameters for various image quality modes according to some implementations.

TABLE 1

| | Basic | Medium | High |
|---|---|---|---|
| | Quality | Quality | Quality |
| Streak Score Fault | 8 | 5.2 | 3.5 |
| Limit | | | |
| Min MiniPurge | 60 | 30 | 30 |
| Interval (minutes) | | | |
| Streak Score Purge | 5.2 | 3.5 | 2.5 |
| Level. When | | | |
| elevated Streak | | | |
| Scores force an | | | |
| autopurge, include | | | |
| colors above this | | | |
| level. | | | |
| MiniPurge Threshold | 60 | 30 (black) | 30 |
| (minutes) | | 60 (C, M&Y) | |

Some exemplary attributes of these implementations, include that operators and service technicians no longer need training to learn how to tune the print engine for print head/missing jet related problems. In addition, low skill operators can change the balance between quality and productivity with a single switch in some implementations. This implementation is faster and easier than prior methods and is less prone to error. Moreover, other system adjustments can be added to the print quality assurance (PQA) infrastructure without having to add any complexity for the user, as the operator instructions remain simple.

As further illustrations of some implementations, the non-transitory instructions which, when executed by the processor, further perform operations comprising: receiving as user selected input one of at least three image quality modes prior to or when generating the print performance prediction for the ink-jet printer 100, wherein the image quality modes comprise a high quality mode, a medium quality mode, and a basic quality mode, wherein the high quality mode produces images having a higher image quality, and at a potentially lower productivity rate, than images produced using the medium quality mode, and wherein the medium quality mode produces images having a higher image quality, and at a potentially lower productivity rate, than images produced using the basic quality mode. In some implementations, the non-transitory instructions which, when executed by the processor, further perform operations comprising: performing one or more maintenance protocols on at least a portion of the one or more of nozzles 104 in the print head 102 when the user selected input is the high quality mode. In some implementations, the non-transitory instructions which, when executed by the processor, further perform operations comprising: receiving as user selected input a selection to enable or disable performing a print head registration process and a nozzle density optimization process when the user selected input is the high quality mode. In some implementations, the non-transitory instructions which, when executed by the processor, further perform operations comprising: receiving as user selected input a selection to enable or disable performing one or more maintenance protocols on at least a portion of the one or more of nozzles 104 in the print head 102, a print head registration process, and a nozzle density optimization process when the user selected input is the medium quality mode. In some implementations, the non-transitory instructions which, when executed by the processor, further perform operations comprising: receiving as user selected input a selection to enable or disable performing one or more maintenance protocols on at least a portion of the one or more of nozzles 104 in the print head 102 when the user selected input is the basic quality mode. In some implementations, the basic quality mode automatically disables performing a print head registration process and a nozzle density optimization process when the user selected input is the basic quality mode.

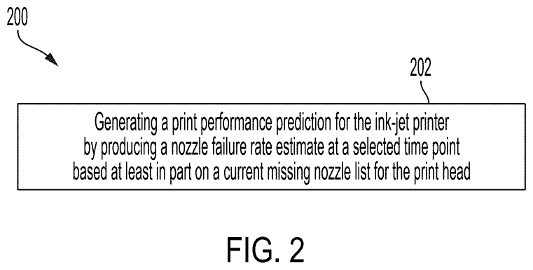

FIG. 2 illustrates a method of predicting print performance of an ink-jet printer according to implementations of the present disclosure. FIG. 2 illustrates an example of a method that, for instance, could be used with the ink-jet printer 100 described above and as illustrated in FIG. 1. As such, the discussion below will reference various components as illustrated in FIG. 1.

As shown in FIG. 2, method 200 comprises producing at least one nozzle failure rate estimate at one or more selected time points based at least in part on a current missing nozzle list for the print head (block 202). In some implementations, the method 200 includes determining actual missing or malfunctioning jets or nozzles using a print substrate. In some implementations, the known number, and the locations, of the failed nozzles in the print head 104 are current. In some implementations, method 200 further includes performing one or more maintenance protocols on at least a portion of the one or more of nozzles 104 in the print head 102 when the at least one nozzle failure rate estimate exceeds a predetermined failure rate value.

In some implementations, a list or table comprises the known number, and the locations, of the failed nozzles in the print head 102. In some implementations, method 200 further comprises appending additional nozzles to the list or table when the additional nozzles exhibit off-axis errors that exceed a predetermined error threshold to produce an expanded set of failed nozzles in the print head 102; and repeating generating the print performance prediction for the ink-jet printer 100 using the expanded set of failed nozzles in the print head.

In some implementations, method 200 includes producing the at least one nozzle failure rate estimate at the one or more selected time points using at least one binomial distribution of nozzle failures of the print head 102 of the ink-jet printer 100 created using a known number, and locations, of failed nozzles in the print head 102. In some implementations, method 200 includes generating at least one print performance prediction for the ink-jet printer using contiguous groups of selected consecutive nozzles from the at least one print head 102. In some implementations, generating the print performance prediction for the ink-jet printer 100 comprises creating the binomial distribution of nozzle failures using the groups of selected consecutive nozzles from the at least one print head 102. In some implementations, generating the print performance prediction for the ink-jet printer 100 comprises: producing at least one histogram that shows numbers of the groups of selected consecutive nozzles from the at least one print head 102 that have a given number of the nozzle failures, wherein the given number of the nozzle failures is from one to a number of the selected consecutive nozzles in each group; and determining the one or more nozzle failure rate estimates at the one or more selected time points using the at least one histogram. In some implementations, generating the print performance prediction for the ink-jet printer 100 comprises: creating at least one vector, wherein each location of a failed nozzle is assigned a value of 1 in the at least one vector and wherein all other nozzles are assigned a value of 0 in the at least one vector; and convolving the at least one vector with at least one function. In some implementations, generating the print performance prediction for the ink-jet printer 100 comprises: weighting at least one of the one or more nozzle failure rate estimates. In some implementations, generating the print performance prediction for the ink-jet printer 100 comprises: estimating at least one selected subgroup size to produce at least one selected subgroup size estimate; and using the at least one selected subgroup size estimate to produce the one or more nozzle failure rate estimates at the one or more selected time points.

In some implementations, method 200 includes generating at least one print performance prediction for the ink-jet printer 100 by calculating a streak score using the known number, and the locations, of the failed nozzles in the print head 102 as reflected in the current missing nozzle list. In some implementations, method 200 further includes performing one or more maintenance protocols on at least a portion of the one or more of nozzles 104 in the print head 102, which maintenance protocols comprise purging at least the portion of the one or more of nozzles 104 in the print head 102. In some implementations, the purging step comprises purging all nozzles of an identical ink color when a predetermined threshold streak score is exceeded. In some implementations, the purging step comprises purging all nozzles having streak scores that exceed a lower limit of the predetermined threshold streak score. In some implementations, a given purging step is automatically performed when a predetermined threshold time interval since a performing previous purging step is exceeded. In some implementations, the predetermined time interval is independently set for each image quality mode and different ink color. In some implementations, method 200 includes outputting a fault notice to a user when the streak score exceeds the predetermined threshold streak score and a predetermined time interval since performing a previous purging step is not exceeded. In some implementations, a timing for performing a given purging step is determined at least in part based on a quality mode selected and/or a streak score determined for print substrates 106 using the ink-jet printer 100. In some implementations, method 200 further includes outputting a notice to a user when the streak score determined for the print substrate 106 exceeds a predetermined threshold streak score and/or another problem associated with the print head 102 is indicated. In some implementations, the predetermined threshold streak score is independently set for each image quality mode and different ink color.

In some implementations, method 200 further includes receiving as user selected input one of at least three image quality modes prior to or when generating at least one print performance prediction for the ink-jet printer 100, wherein the image quality modes comprise a high quality mode, a medium quality mode, and a basic quality mode, wherein the high quality mode produces images having a higher image quality, and at a potentially lower productivity rate, than images produced using the medium quality mode, and wherein the medium quality mode produces images having a higher image quality, and at a potentially lower productivity rate, than images produced using the basic quality mode. In some implementations, method 200 further includes performing one or more maintenance protocols on at least a portion of the one or more of nozzles 104 in the print head 102 when the user selected input is the high quality mode. In some implementations, method 200 further includes receiving as user selected input a selection to enable or disable performing a print head registration process and a nozzle density optimization process when the user selected input is the high quality mode. In some implementations, method 200 further includes receiving as user selected input a selection to enable or disable performing one or more maintenance protocols on at least a portion of the one or more of nozzles 104 in the print head 102, a print head registration process, and a nozzle density optimization process when the user selected input is the medium quality mode. In some implementations, method 200 further includes receiving as user selected input a selection to enable or disable performing one or more maintenance protocols on at least a portion of the one or more of nozzles 104 in the print head 102 when the user selected input is the basic quality mode. In some implementations, the basic quality mode automatically disables performing a print head registration process and a nozzle density optimization process when the user selected input is the basic quality mode.

As a further illustration, FIG. 3 depicts a method of performing a maintenance protocol on a print head of an ink-jet printer according to implementations of the present disclosure. As shown, method 300 includes printing a missing jet test pattern at cycle up and at the selected runtime interval, if enabled (block 302). Method 300 also includes scanning and analyzing the test pattern and creating a missing jet list for each print head (block 304). In some implementations, the missing jet list contains all weak, missing, and misdirected jets or nozzles that would cause streaks if not corrected. After block 304, the missing jet list is sent to a missing jet correction algorithm which will actively hide missing jets while printing (block 306). The missing jet correction algorithm typically works well if missing jets are not clustered. The streak score measures clustering. The streak score fault levels are typically designed to intervene when a user or operator is dissatisfied with the output based on the selected quality level. After block 304, method 300 also includes sending the missing jet list to a streak score calculator (block 308). A streak score value is typically calculated for each print head and each print bar. Once the streak score is calculated, method 300 queries whether there are any streak scores above the fault threshold for the current quality level in block 310. If the answer is NO, then method 300 returns to block 302. If the answer is YES, then method 300 queries whether the measurement is after a purge (block 312). If the answer is YES, then method 300 notifies the operator per the selected method (block 318). In some implementations, a log is updated and printing continues, an alert is displayed and printing continues, or an alert is displayed and printing discontinues. If the answer is NO, then method 300 queries whether more than the minimum purge interval time has passed since the last purge (block 314). If the answer is YES, then method 300 automatically purges the print heads. If the answer is NO, then method 300 notifies the operator per the selected method (block 316). In some implementations, a log is updated and printing continues, an alert is displayed and printing continues, or an alert is displayed and printing discontinues.

The present disclosure has been described with reference to exemplary implementations. Although a few implementations have been shown and described, it will be appreciated by those skilled in the art that changes may be made in these implementations without departing from the principles and spirit of preceding detailed description. It is intended that the present disclosure be construed as including all such modifications and alterations insofar as they come within the scope of the appended claims or the equivalents thereof.

What is claimed, is:

1. An ink-jet printer, comprising:
at least one print head comprising one or more nozzles; and
at least one controller operatively connected to the least one print head, wherein the controller comprises at least one processor and at least one memory communicatively coupled to the processor, the memory storing non-transitory instructions which, when executed by the processor, perform operations comprising:
generating a print performance prediction for the ink-jet printer by producing one or more nozzle failure rate estimates at one or more selected time points based at least in part on a current missing nozzle list for the print head.

2. The ink-jet printer of claim 1, wherein generating the print performance prediction for the ink-jet printer comprises calculating a streak score using a known number, and locations, of the failed nozzles in the print head as reflected in the current missing nozzle list.

3. The ink-jet printer of claim 2, wherein the non-transitory instructions which, when executed by the processor, further perform operations comprising:
performing one or more maintenance protocols on at least a portion of the one or more of nozzles in the print head, which maintenance protocols comprise purging at least the portion of the one or more of nozzles in the print head.

4. The ink-jet printer of claim 1, wherein generating the print performance prediction for the ink-jet printer comprises producing the one or more nozzle failure rate estimates at the one or more selected time points using at least one binomial distribution of nozzle failures created using a known number, and locations, of failed nozzles in the print head.

5. The ink-jet printer of claim 4, wherein generating the print performance prediction for the ink-jet printer comprises using contiguous groups of selected consecutive nozzles from the at least one print head.

6. The ink-jet printer of claim 5, wherein generating the print performance prediction for the ink-jet printer comprises creating the binomial distribution of nozzle failures using the groups of selected consecutive nozzles from the at least one print head.

7. The ink-jet printer of claim 5, wherein generating the print performance prediction for the ink-jet printer comprises:
producing at least one histogram that shows numbers of the groups of selected consecutive nozzles from the at least one print head that have a given number of the nozzle failures, wherein the given number of the nozzle failures is from one to a number of the selected consecutive nozzles in each group; and
determining the one or more nozzle failure rate estimates at the one or more selected time points using the at least one histogram.

8. The ink-jet printer of claim 5, wherein generating the print performance prediction for the ink-jet printer comprises:
creating at least one vector, wherein each location of a failed nozzle is assigned a value of 1 in the at least one vector and wherein all other nozzles are assigned a value of 0 in the at least one vector; and
convolving the at least one vector with at least one function.

9. The ink-jet printer of claim 5, wherein generating the print performance prediction for the ink-jet printer comprises:
weighting at least one of the one or more nozzle failure rate estimates.

10. The ink-jet printer of claim 1, wherein the non-transitory instructions which, when executed by the processor, further perform operations comprising:
receiving as user selected input one of at least three image quality modes prior to or when generating the print performance prediction for the ink-jet printer, wherein the image quality modes comprise a high quality mode, a medium quality mode, and a basic quality mode, wherein the high quality mode produces images having a higher image quality, and at a potentially lower productivity rate, than images produced using the medium quality mode, and wherein the medium quality mode produces images having a higher image quality, and at a potentially lower productivity rate, than images produced using the basic quality mode.

11. A method of predicting print performance of an ink-jet printer, the method comprising producing at least one nozzle failure rate estimate for at least one print head of the ink-jet printer at one or more selected time points based at least in part on a current missing nozzle list for the print head, thereby predicting print performance of an ink-jet printer.

12. The method of claim 11, comprising generating at least one print performance prediction for the ink-jet printer by calculating a streak score using a known number, and locations, of failed nozzles in the at least one print head as reflected in the current missing nozzle list.

13. The method of claim 12, further comprising:
performing one or more maintenance protocols on at least a portion of the one or more of nozzles in the at least one print head, which maintenance protocols comprise purging at least the portion of the one or more of nozzles in the at least one print head.

14. The method of claim 11, comprising producing the at least one nozzle failure rate estimate at the one or more selected time points using at least one binomial distribution of nozzle failures of the at least one print head of the ink-jet printer created using a known number, and locations, of failed nozzles in the at least one print head.

15. The method of claim 14, comprising generating at least one print performance prediction for the ink-jet printer using contiguous groups of selected consecutive nozzles from the at least one print head.

16. The method of claim 15, wherein generating the print performance prediction for the ink-jet printer comprises creating the binomial distribution of nozzle failures using the groups of selected consecutive nozzles from the at least one print head.

17. The method of claim 15, wherein generating the print performance prediction for the ink-jet printer comprises:
producing at least one histogram that shows numbers of the groups of selected consecutive nozzles from the at least one print head that have a given number of the nozzle failures, wherein the given number of the nozzle failures is from one to a number of the selected consecutive nozzles in each group; and
determining the one or more nozzle failure rate estimates at the one or more selected time points using the at least one histogram.

18. The method of claim 15, wherein generating the print performance prediction for the ink-jet printer comprises:
creating at least one vector, wherein each location of a failed nozzle is assigned a value of 1 in the at least one vector and wherein all other nozzles are assigned a value of 0 in the at least one vector; and
convolving the at least one vector with at least one function.

19. The method of claim 15, wherein generating the print performance prediction for the ink-jet printer comprises:
weighting at least one of the one or more nozzle failure rate estimates.

20. The method of claim 11, further comprising:
receiving as user selected input one of at least three image quality modes prior to or when generating at least one print performance prediction for the ink-jet printer, wherein the image quality modes comprise a high quality mode, a medium quality mode, and a basic quality mode, wherein the high quality mode produces images having a higher image quality, and at a potentially lower productivity rate, than images produced using the medium quality mode, and wherein the medium quality mode produces images having a higher image quality, and at a potentially lower productivity rate, than images produced using the basic quality mode.
